(19) United States
(12) Patent Application Publication
(10) Pub. No.: US 2009/0166202 A1
(43) Pub. Date: Jul. 2, 2009

(54) INJECTION METHOD FOR MICROFLUIDIC CHIPS

(75) Inventors: Wei-Cheng Tian, Clifton Park, NY (US); Erin Jean Finehout, Clifton Park, NY (US); Li Zhu, Clifton Park, NY (US); Jun Xie, Niskayuna, NY (US); Shashi Thutupalli, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/965,791

(22) Filed: Dec. 28, 2007

(51) Int. Cl. B01D 57/02

(52) U.S. Cl. 204/453; 204/604

(57) ABSTRACT

A microchip for electrophoresis is provided. The microchip comprises an injection channel and a separation channel configured to receive a sample through a sample well. The injection channel and the separation channel form a ‘T’ junction. The microchip comprises a first electrode disposed at a first end of the separation channel, a second electrode disposed in front of the ‘T’ junction and adjacent to the first electrode, a third electrode disposed at a first end of the injection channel and a fourth electrode disposed at a second end of the separation channel. A portion of the sample is injected and separated into an area between the ‘T’ junction and the fourth electrode.

### BACKGROUND

The invention relates generally to microfluidic chips and more specifically to injection methods for microfluidic chips.

Electrophoretic separation of bio-molecules is very important in modern biology and biotechnology applications such as DNA sequencing, protein analysis and genetic mapping. Electrophoresis is a process by which individual molecular species are separated in a conductive medium (such as a liquid solution or a cross-linked polymer) by applying an electric field. The charged molecules migrate through the media and separate into distinct bands due to their mobility difference. The rates are influenced by factors such as a viscosity of the media, a mass and charge of the molecules, and a strength and duration of the electric field.

An increase in a voltage gradient (V/cm) applied to the electrophoretic device results in a corresponding decrease in the time needed to perform the separation. However, increasing the voltage gradient is governed by certain constraints. For example, increasing the voltage gradient beyond a certain point may result in an increase in joule heating which would in turn alter the properties of the medium in which the molecules are being separated. The change of the medium properties leads to an increase in sample diffusion and thus degraded the separation resolution. In order to alleviate the above limitations, electrophoresis can be performed in a capillary or miniaturized channel. The large surface-area-to-volume ratio of the electrophoretic devices offers efficient dissipation of Joule heat, allowing higher electric field to be used, thus resulting in the shorter analysis time and better separation efficiency.

Microchips are small microfluidic devices that perform chemical and physical operations such as capillary electrophoresis with microscale sample volumes. These devices often have the benefits of fast reactions, rapid detection, small reagent consumption, ease of automation and simple transfer between reaction vessels. Microfluidic devices are commonly referred to as “lab-on-a-chip.”

In microchip electrophoresis, a sample is loaded in a sample reservoir and a voltage is applied between a sample reservoir and a waste reservoir to move sample into the loading channel. However, proteins with different mobilities may result in a biased injection, in which the sample injected into the separation channel does not represent the original sample composition. Long injection time is usually applied to overcome the biased injection.

Therefore, there is a need for a microfluidic device that provides fast sample loading technique where the sample composition is uniform at the injection point.

### BRIEF DESCRIPTION

In one embodiment, a microchip for electrophoresis is provided. The microchip comprises an injection channel, a separation channel configured to receive a sample through a sample well. The injection channel and the separation channel form a ‘T’ junction. The microchip further comprises a first electrode disposed at a first end of the separation channel, a second electrode disposed in front of the ‘T’ junction and adjacent to the first electrode, a third electrode disposed at a first end of the injection channel and a fourth electrode disposed at a second end of the separation channel. A portion of the sample is electro-kinetically injected into an area between the ‘T’ junction and the fourth electrode during electrophoresis.

In another embodiment, a method for electrophoresis is provided. The method comprises forming an injection channel, forming a separation channel; wherein the injection channel and the separation channel form a ‘T’ junction, disposing a first electrode at a first end of the separation channel, disposing a second electrode in front of the ‘T’ junction and adjacent to the first electrode, disposing a third electrode at a first end of the injection channel; and disposing a fourth electrode at a second end of the separation channel. During electrophoresis, a portion of the sample is electro-kinetically injected into an area between the ‘T’ junction and the fourth electrode.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of one embodiment of a microchip implemented according to one aspect of the invention;

FIG. 2 is a flow chart illustrating one method by which a sample can be injected into a microchip device;

### DETAILED DESCRIPTION

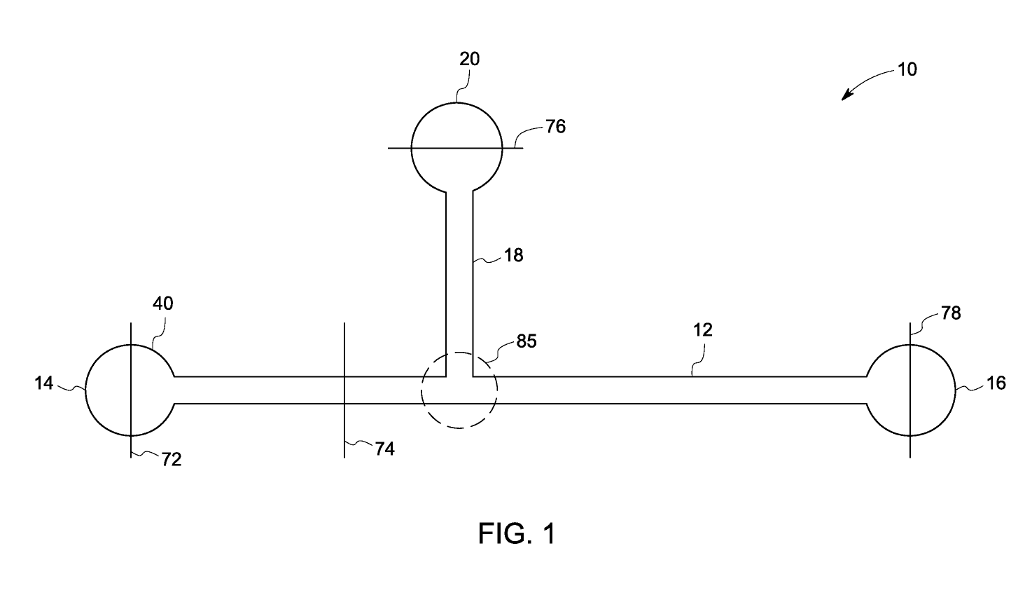

FIG. 1 is a block diagram of one embodiment of a microchip implemented according to one aspect of the invention. Each component of the microchip device is described in further detail below.

Microchip 10 comprises an injection channel 18 and separation channel 12. The separation channel 12 is configured to receive a sample 40 through a well 14 or 20. In a specific embodiment, the sample is loaded through well 20. The injection channel and the separation channel form a three way channel or ‘T’ junction 85. During electrophoresis, a portion of the sample is injected into an area between the ‘T’ junction 85 and the fourth electrode 78.

Microchip 10 includes a first electrode 72 disposed at a first end 14 of the separation channel. A second electrode 74 is disposed in front of the ‘T’ junction 85 and adjacent to the first electrode 72. A third electrode 76 is disposed at a first end 20 of the injection channel. A fourth electrode 78 is disposed at a second end of the separation channel.

In one embodiment, a distance between the second electrode and the ‘T’ junction is less that 1 millimeter. In a further embodiment, a distance between the second electrode and the ‘T’ junction is less than 200 micrometers. At least one voltage source is electrically connected to each of the first, second, third and fourth electrode. The manner in which electrophoresis occurs is described in further detail below.

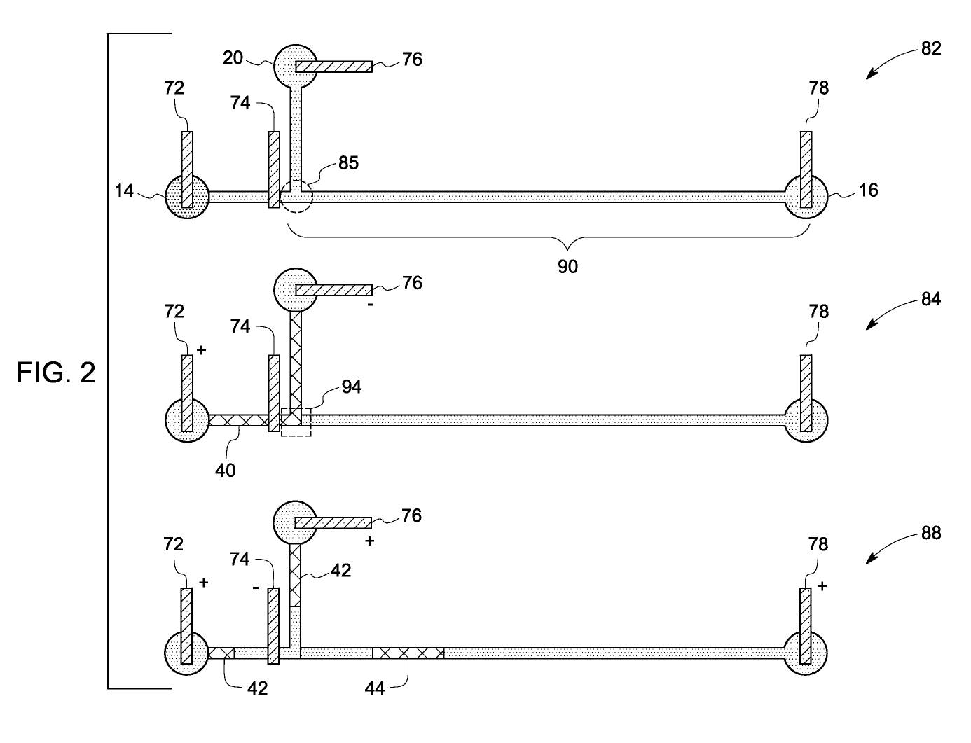

FIG. 2 is a flow chart illustrating one method by which a sample can be injected into a microchip device for electrophoresis. The following technique is adapted for use in microchips having the injection channel and the sample channel forming a three-way junction. Each step is described in further detail below.

In step 82, a first electrode 72 is disposed at a first end 14 of the separation channel. A second electrode 74 is disposed in front of the ‘T’ junction represented by 85 and adjacent to the first electrode 72. A third electrode 76 is disposed at a first end 20 of the injection channel. A fourth electrode 78 is disposed at a second end 16 of the separation channel.

In step 84, a sample 40 is loaded into the separation channel by applying a load voltage across the first electrode 72 and the third electrode 76. The second electrode 74 and the fourth electrode 78 are maintained at a floating voltage. In one embodiment, sample 40 can also be loaded through a capillary force to fill the channels in between the first electrode 72 and third electrode 76, if the sieving matrix is filled partially between junction 94 and forth electrode 78.

In step 86, a separation voltage is applied across second electrode 74 and fourth electrode 78. A portion of the sample 44 is injected in to region 90 of the separation channel. In one embodiment, the portion of the sample that injects into the separation channel is defined by an area 94 measured between the second electrode and the ‘T’ junction. A pull back voltage is applied at electrodes 72 and 76. Due to the capillary force, sample preconcentration and stacking effect at the interface of sieving matrix and the sample is obtained.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A microchip for electrophoresis, the microchip comprising:
an injection channel is configured to receive a sample through a sample well;
a separation channel comprising a buffer well and configured to receive a sieving matrix; wherein the injection channel and the separation channel form a ‘T’ junction; wherein the sieving matrix occupies a region after the ‘T’ junction;
a first electrode disposed at a first end of the separation channel;
a second electrode disposed in front of the ‘T’ junction and adjacent to the first electrode;
a third electrode disposed at a first end of the injection channel; and
a fourth electrode disposed at a second end of the separation channel; wherein a portion of the sample is injected and separated into an area between the ‘T’ junction and the fourth electrode.

2. The microchip of claim 1, wherein the sample is loaded to the separation channel by applying a load voltage across the first electrode and the third electrode.

3. The microchip of claim 2, wherein the first electrode is maintained at a positive voltage and the third electrode is maintained at a negative voltage and the sample is negatively charged.

4. The microchip of claim 1, wherein the sample is injected and separated in to the separation channel by applying a separation voltage across the fourth electrode and the second electrode.

5. The method of claim 1, wherein loading the sieving matrix comprises loading a predetermined amount of the sieving matrix

6. The method of claim 1, wherein the separation channel is partially loaded with a predetermined amount of the sieving matrix.

7. The microchip of claim 1, wherein the portion of the sample that injects into the separation channel is defined by an area between the second electrode and the ‘T’ junction.

8. A method for electrophoresis, the method comprising:
forming an injection channel;
forming a separation channel; wherein the injection channel and the separation channel form a ‘T’ junction;
disposing a first electrode at a first end of the separation channel;
disposing a second electrode in front of the ‘T’ junction and adjacent to the first electrode;
disposing a third electrode at a first end of the injection channel; and
disposing a fourth electrode at a second end of the separation channel; wherein a portion of a sample is separated into an area between the ‘T’ junction and the fourth electrode.

9. The method of claim 8, further comprising loading a sample by applying a load voltage across the first electrode and the third electrode.

10. The method of claim 9, wherein the loading the sample comprises loading the sample into the injection channel.

11. The method of claim 9, wherein the loading the sample comprises loading the sample into the separation channel.

12. The method of claim 8, further comprising applying a separation voltage across the fourth electrode and the second electrode for separating the sample into the separation channel.

13. The method of claim 12, further comprising applying a pull back voltage between the first electrode, the third electrode and the second electrode.

14. The method of claim 13, wherein the first electrode and the third electrode is maintained at a positive voltage and the second electrode is maintained at a negative voltage.

15. The method of claim 8, wherein the separation channel is partially filled with a polymer sieving matrix.

16. The method of claim 8, further comprising obtaining a sample preconcentration and stacking effect at an interface of sieving matrix and the sample.

17. The method of claim 8, wherein the portion of the sample that injects into the separation channel is defined by an area between the second electrode and the ‘T’ junction.
